(19) United States
(12) Patent Application Publication
(10) Pub. No.: US 2006/0150171 A1
(43) Pub. Date: Jul. 6, 2006

(54) Control words for instruction packets of processors and methods thereof

(75) Inventors: Yuval Sapir, Tel Aviv (IL); Michael Boukaya, Raanana (IL); Roy Glasner, Ramat Gan (IL); Eran Briman, Sunnyvale, CA (US); Hagay Gellis, Netanya (IL)

Correspondence Address: PEARL COHEN ZEDEK, LLP, 1500 BROADWAY 12TH FLOOR, NEW YORK, NY, 10036, US

(73) Assignee: Ceva D.S.P. Ltd.

(21) Appl. No.: 11/022,852

(22) Filed: Dec. 28, 2004

(51) Int. Cl. G06F 9/45

(52) U.S. Cl. 717/159

(57) ABSTRACT

An instruction packet having an extended machine language instruction may include at least a machine language instruction having encoded bits of an operation and a control word including bits of one or more extension fields. The structure and meaning of the extension fields may depend upon the extended machine language instruction. An association between an extension field and a machine language instruction may depend on the relative position of the extension field and the machine language instruction in the instruction packet.

### BACKGROUND OF THE INVENTION

A processor has an instruction set. Software programmers may write assembly language instructions that are translated by an assembler tool into machine language instructions belonging to the instruction set. Alternatively, software programmers may write programs in a higher-level language that are compiled by a compiler into assembly language instructions. Machine language instructions to be executed in parallel by the various functional units of the processor may be combined in an instruction packet. It is generally desirable to reduce the size of the machine language code stored in a program memory accessed by the processor. It may also be desirable to increase the instruction parallelism of the processor.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary device including an integrated circuit, a data memory and a program memory, the integrated circuit including a processor according to some embodiments of the invention;

FIGS. 2A-2D are schematic diagrams of instruction packets, according to some embodiments of the invention;

FIGS. 3A-3D are schematic diagrams of instruction packets, according to some embodiments of the invention;

FIGS. 4A-4B are schematic diagrams of instruction packets, according to some embodiments of the invention; and

FIG. 5 is a flowchart of a method performed by the dispatcher of the processor of FIG. 1 according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

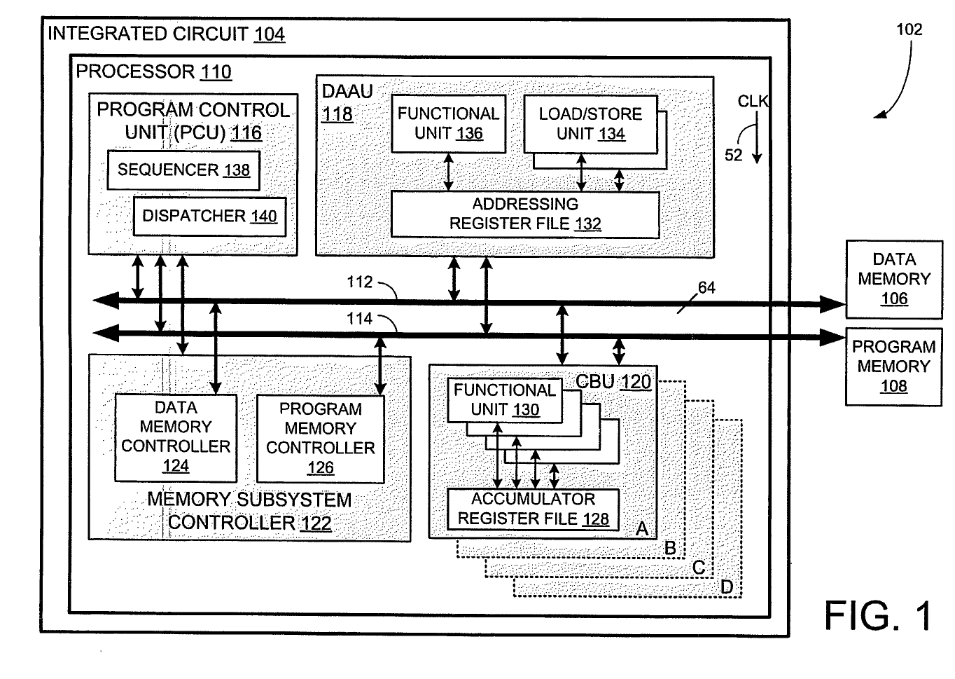

FIG. 1 is a block diagram of an exemplary apparatus 102 including an integrated circuit 104, a data memory 106 and a program memory 108. Integrated circuit 104 includes an exemplary processor 110 that may be, for example, a digital signal processor (DSP), and processor 110 is coupled to data memory 106 via a data memory bus 112 and to program memory 108 via a program memory bus 114. Data memory 106 and program memory 108 may be the same memory or alternatively, separate memories. An exemplary architecture for processor 110 will now be described, although other architectures are also possible. Processor 110 includes a program control unit (PCU) 116, a data address and arithmetic unit (DAAU) 118, a computation and bit-manipulation unit (CBU) 120, and a memory subsystem controller 122. Memory subsystem controller 122 includes a data memory controller 124 coupled to data memory bus 112 and a program memory controller 126 coupled to program memory bus 114. PCU 116 includes a dispatcher 140 to pre-decode and dispatch machine language instructions and a sequencer 138 that is responsible for retrieving the instructions and for the correct program flow. CBU 120 includes an accumulator register file 128 and functional units (FUs) 130, having any of the following functionalities or combinations thereof: multiply-accumulate (MAC), add/subtract, bit manipulation, arithmetic logic, and general operations. DAAU 118 includes an addressing register file 132, load/store units 134 to load and store from/to data memory 116, and a functional unit 136 having arithmetic, logical and shift functionality.

Processor 110 has an instruction set. A software programmer may write a program in assembly language, Alternatively, a software programmer may write a program in a higher-level language, and a compiler tool will convert the program to assembly language. An assembler tool will convert the assembly language program to machine language. The compiler tool may build “instruction packets” of assembly language instructions. The assembler tool will convert these instruction packets to packets of machine language instructions belonging to the instruction set, and control words. The machine language instructions in an instruction packet are to be executed in parallel by processor 110. The control words may affect the execution of one or more of the machine language instructions.

Program memory controller 126 may retrieve instruction packets from program memory 108 and provide them to PCU 116. For example, in each clock cycle, PCU 116 may retrieve an instruction packet from program memory 108.

Control words may affect the execution of machine language instructions in the processor in different ways, including, for example:
(a) extending one or more operands that are partially encoded within a machine language instruction, such as immediate operands and target addresses of branch operations;
(b) encoding an optional operand that is not encoded within a machine language instruction;
(c) extending the operation field of a machine language instruction; and
(d) providing a header for the instruction packet.
   These and other ways for control words to affect the execution of machine language instructions in the processor are discussed in greater detail hereinbelow.

Dispatcher 140 receives the instruction packet, identifies its entries (machine language instructions and control words), and sends each operation, its operands, and any extensions, to the appropriate functional unit of DAAU 118 or CBU 120 or to sequencer 138.

Both the assembler tool and dispatcher 140 work with a predefined framework regarding permissible formats of instruction packets and a predefined coding scheme for the machine language instructions and control words. A control word may include identification bits and content bits. The content bits may include one or more extension fields. According to embodiments of the present invention, the predefined framework may have one or more of the following properties:
a) control words are optional;
b) machine language instructions to be extended are valid (i.e. interpretable by dispatcher 140) even without an extension;
c) a single control word may include extension fields for one or more machine language instructions;
d) linkage between control words and machine language instructions depends upon their relative position in an instruction packet; and
e) flexibility—the structure and meaning of each extension field depends upon its corresponding extended machine language instruction.

In the following examples, instruction packets have at most 256 bits, machine language instructions are 32-bit instructions or 16-bit instructions, and control words are 32-bit control words or 16-bit control words. An instruction packet may include up to eight entries (machine language instructions and/or control words), regardless of their size. Consequently, if an assembler tool or compiler tool uses 16-bit control words rather than 32-bit control words whenever possible, this may reduce the code size. Furthermore, in the following example, 6 or 8 bits of the control word are used to identify the control word, and the native data width of operands is 32 bits. However, in other embodiments, other sizes of control words, machine language instructions and instruction packets may be used. Similarly, in other embodiments, the maximum number of entries per instruction packet may be different. Similarly, in other embodiments, different native data widths or a configurable native data width is possible. Similarly, in other embodiments, the number of identification bits in a control word may be different.

Extension of Operands

Control words may be used to extend an operand that is partially encoded in a machine language instruction. A non-exhaustive list of such operands includes immediate operands and address operands.

Extension of Address Operands

The number of bits allocated in a machine language instruction for a value of an address operand may be less than the processor address width. For example, a 32-bit machine language instruction format may have 6 bits allocated for encoding an address operand, such as the target address of a branch operation. If the number of bits required to represent the value of a particular address operand does not exceed the number of bits allocated in the machine language instruction format for an address operand, then a single machine language instruction may have sufficient bits to encode the address operand. In this respect, the control word is not needed. However, if the number of bits required to represent the value of the particular address operand exceeds the number of bits allocated in the machine language instruction format for encoding an address operand, then a control word may be used to aid in the encoding of the address operand. For example, least significant bits of the address operand may be encoded in the machine language instruction, and higher-order bits of the address operand may be encoded in a control word.

Extension of Immediate Operands

The number of bits allocated in a machine language instruction for a value of an immediate operand may be less than the native data width. For example, a 32-bit machine language instruction format may have 6 bits allocated for encoding of an immediate operand. If the number of bits required to represent the value of a particular immediate operand does not exceed the number of bits allocated in the machine language instruction format for an immediate operand, then a single machine language instruction may have sufficient bits to encode the immediate operand. In this respect, the control word is not needed. However, if the number of bits required to represent the value of the particular immediate operand exceeds the number of bits allocated in the machine language instruction format for an immediate operand, then a control word may be used to aid in the encoding of the immediate operand. For example, least significant bits of the immediate operand may be encoded in the machine language instruction, and higher-order bits of the immediate operand may be encoded in a control word.

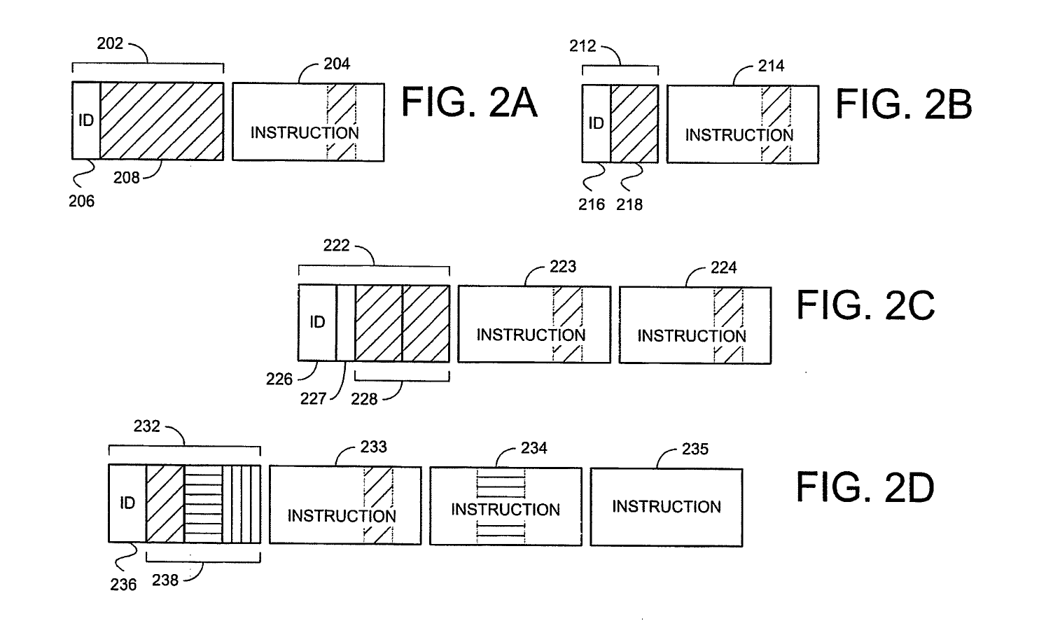

FIG. 2A shows an instruction packet including a control word 202 and an instruction 204. Control word 202 includes identification bits 206 and content bits 208. In one example, instruction 204 is a 32-bit instruction and has 6 bits allocated to encode an immediate operand (marked in FIG. 2A by diagonal lines), the native data width is 32 bits, control word 202 is a 32-bit control word and has 6 identification bits 206 and 26 content bits 208. Control word 202, together with the allocated 6 bits of instruction 204, is sufficient to encode any immediate operand.

FIG. 2B shows an instruction packet including a control word 212 and an instruction 214. Control word 212 includes identification bits 216 and content bits 218. In one example, instruction 214 is a 32-bit instruction and has 6 bits allocated to encode an immediate operand (marked in FIG. 2B by diagonal lines), the native data width is 32 bits, control word 212 is a 16-bit control word and has 6 identification bits 216 and 10 content bits 218. Control word 212, together with the allocated 6 bits of instruction 214, is sufficient to encode any immediate operand having a value that can be represented by 16 bits or less.

The use of short control words instead of long control words may reduce the code size. For certain specific instruction packets, a short control word has enough content bits to support a particular feature to control one or more of the machine language instructions in that specific instruction packet. For example, if the value of an immediate operand is greater than 6 bits (which are allocated in the instruction) but does not exceed 16 bits, a 16-bit control word (that has 10 content bits) will suffice. However, for other instruction packets, the short control word might not have enough content bits to support that same particular feature to control one or more of the machine language instructions of the other instruction packets. For example if the value of an immediate operand exceeds 16 bits, a 16-bit control word will not suffice.

The size of the control word depends on how many additional bits of the immediate operand one needs in order to fully encode the immediate operand, and that number depends on a) the native data width, b) the number of bits allocated in the machine language instruction format for encoding an immediate operand, and c) the number of bits that are needed to encode the value of the specific immediate operand that is used in the specific instruction.

If the same machine language instructions are to be used in different processors having different native data widths, then the number of bits allocated in the machine language instruction format for, encoding an immediate operand may be the same for those different processors This number of bits may be less than some of the native data widths, and in such cases, the minimum number of content bits of the control word is dependent on the native data width. The control words described herein may therefore be considered to be scalable with respect to the native data width.

Extension of Operations

Control words may be used to extend an operation that is partially encoded in a machine language instruction. For example, a machine language instruction representing the assembly language instruction
add a0, a1, a2
may be extended by a control word that includes a bit that indicates that the extended instruction is to add the value 1 to the contents of register a0 and the contents of register a1 and to store the sum in register a2.
Extension of Conditions

Control words may be used to extend a condition code that is partially encoded in a machine language instruction. The control word extends the partially encoded condition code to a full condition code.

Single Control Word Includes Extensions for Two or More Instructions

Extension fields for two or more instructions may be included in the same control word. FIG. 2C shows an instruction packet including a control word 222 and instructions 223 and 224. Control word 222 includes identification bits 226, unused bits 227 and content bits 228. In one example, instructions 223 and 224 are each 32-bit instructions and each have 6 bits allocated to encode an immediate operand (marked in FIG. 2C by diagonal lines), the native data width is 32 bits, control word 222 is a 32-bit control word and has 6 identification bits 226 and 20 content bits 228. An extension field of 10 of content bits 228 extends an immediate operand of instruction 223, and another extension field of 10 of content bits 228 extends an immediate operand of instruction 224. The ability to include extension fields of more than one machine language instruction in a single control word may reduce the code size, and/or may enable additional instructions and/or control words to be included in the instruction packet.

FIG. 2D shows an instruction packet including a control word 232 and instructions 233, 234 and 235. Control word 232 includes identification bits 236 and content bits 238. In one example, instructions 233, 234 and 235 are each 32-bit instructions. Instruction 233 has 6 bits allocated to encode an immediate operand (marked in FIG. 2D by diagonal lines), and instruction 234 has an arbitrary number of bits allocated to encode an operation (marked in FIG. 2D by horizontal lines). The native data width is 32 bits, control word 232 is a 32-bit control word and has 8 identification bits 236 and 24 content bits 238. An extension field of 8 of content bits 238 extends an immediate operand of instruction 233, another extension field of 8 of content bits 238 extends an operation of instruction 234 and another extension field of 8 of content bits 238 provides an optional operand of instruction 235. As illustrated by this example, the extension fields of a control word need not serve the same purpose for the different instructions. Indeed, the structure and meaning of each extension field depends upon its corresponding extended machine language instruction.

Linkage Between Control Words and Instructions

According to some embodiments of the invention, the connection between control words and instructions may depend on their relative location in the instruction packet. Moreover, the instructions do not need to include an indication of the presence of an extension field in the instruction packet, nor does the control word need to include an identification of the functional unit whose instruction is being extended. Different linkage frameworks are possible.

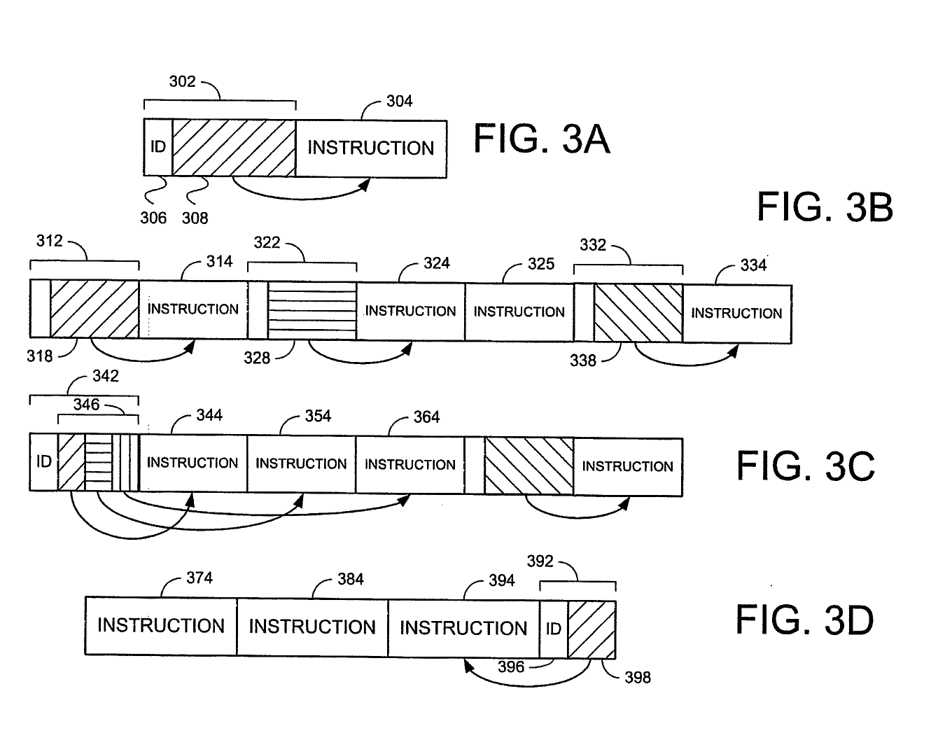

One exemplary linkage framework is illustrated in FIGS. 3A-3D. This exemplary linkage framework has the following rules:
(i) a 32-bit control word that extends a single instruction extends the instruction that immediately follows the control word in the instruction packet;
(ii) a 32-bit control word that extends two or more instructions, extends the instructions that immediately follow the control word in the instruction packet, and the order of the extension fields in the control word corresponds to the order of the extended instructions in the instruction packet; and
(iii) a 16-bit control word extends the instruction that immediately precedes the control word in the instruction packet.

Rule (i) is illustrated in FIG. 3A, which shows an instruction packet including a control word 302 and an instruction 304. Control word 302 includes identification bits 306 and content bits 308. In this example, control word 302 is a 32-bit control word and extends the instruction that follows it in the instruction packet, namely instruction 304.

Rule (i) is also illustrated in FIG. 3B, which shows an instruction packet including a 32-bit control word 312, followed by an instruction 314 that is extended by content bits 318 of control word 312, followed by a 32-bit control word 322, followed by an instruction 324 that is extended by content bits 328 of control word 322, followed by an instruction 325, followed by a 32-bit control word 332, followed by an instruction 334 that is extended by content bits 338 of control word 332.

Rule (ii) is illustrated in FIG. 3C, which shows an instruction packet having a 32-bit control word 342, followed by an instruction 344, followed by an instruction 354, followed by an instruction 364. Content bits 346 of control word 342 include three extension fields, and instruction 344 is extended by the first extension field, instruction 354 is extended by the second extension field, and instruction 364 is extended by the third extension field. Instruction 364 is followed by another 32-bit control word having a single extension field, which is followed by another instruction.

Rule (iii) is illustrated by FIG. 3D, which shows an instruction packet including an instruction 374 followed by an instruction 384 followed by an instruction 394 followed by a 16-bit control word 392. Control word 392 includes identification bits 396 and content bits 398. Instruction 394 is extended by content bits 398.

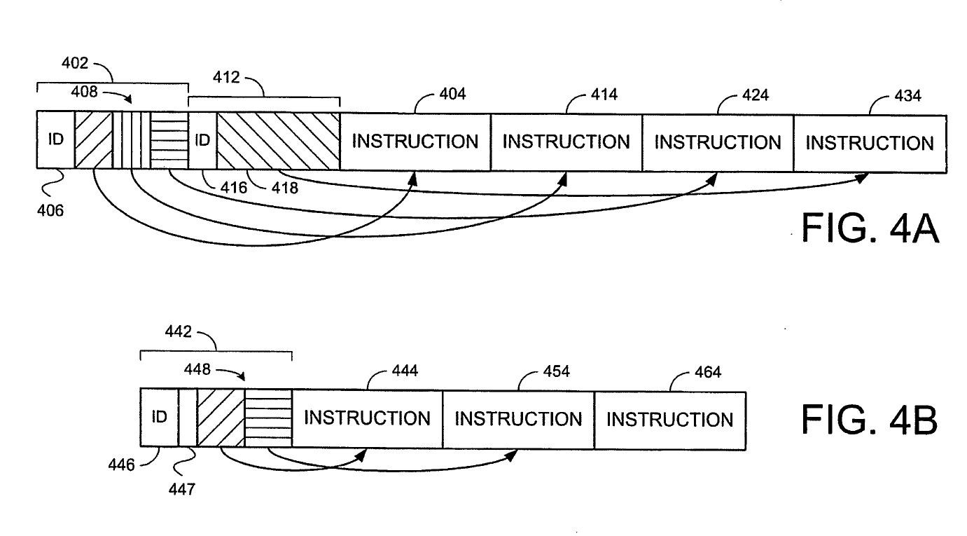

A different exemplary linkage framework is illustrated in FIGS. 4A and 4B. In this exemplary linkage framework, all control words are concentrated at the beginning of the instruction packet and the instructions follow the control words in the order of the extension fields, followed by instructions that are not extended, if any.

FIG. 4A shows an instruction packet including a control word 402, followed by a control word 422, followed by instructions 404, 414, 424 and 434, in that order. Control words 402 and 412 include identification bits 406 and 416, respectively and content bits 408 and 418, respectively. Content bits 408 of control word 402 include three extension fields, and instruction 404 is extended by the first extension field, instruction 414 is extended by the second extension field, and instruction 424 is extended by the third extension field. Instruction 434 is extended by content bits 418.

FIG. 4B shows an instruction packet having a control word 442 followed by instructions 444, 454 and 464, in that order. Control word 442 includes identification bits 446, unused bits 447, and control bits 448 including two extension fields. Instruction 444 is extended by the first extension field, instruction 454 is extended by the second extension field, and instruction 464 is not extended.

Multiple Computation Clusters

Returning briefly to FIG. 1, processor 110 may have more than one instance of CBU 120. Each instance is termed a “computation cluster”. For example, processor 110 may include one, two or four computation clusters, denoted cluster “A”, cluster “B”, cluster “C”, and cluster “D”, and having accumulator register files with registers labeled with the letter “a”, “b”, “c” and “d”, respectively. The computation clusters may work in parallel and independently of one another.

Instruction Replication

To enable processor 110 to execute the same instruction concurrently on different data, commonly known as single-instruction-multiple-data (SIMD), an instruction replication feature may be implemented. The instruction replication feature may reduce the code size of the machine language code, and/or may enable an increase in the number of instructions executed per cycle by processor 110.

The instruction replication feature may make use of an instruction replication control word. As with other control words, an instruction replication control word includes identification bits and content bits. If, for example, each computation cluster includes four functional units, denoted <<1>>, <<2>>, <<3>> and <<4>>, then the content bits of the instruction replication control word may include a 12-bit mask, one bit for each functional unit of clusters “B”, “C” and “D”:

| BIT | FIELD |
|---|---|
| 11 | “FU <<1>> (cluster B)” valid bit |
| 10 | “FU <<2>> (cluster B)” valid bit |
| 9 | “FU <<3>> (cluster B)” valid bit |
| 8 | “FU <<4>> (cluster B)” valid bit |
| 7 | “FU <<1>> (cluster C)” valid bit |
| 6 | “FU <<2>> (cluster C)” valid bit |
| 5 | “FU <<3>> (cluster C)” valid bit |
| 4 | “FU <<4>> (cluster C)” valid bit |
| 3 | “FU <<1>> (cluster D)” valid bit |
| 2 | “FU <<2>> (cluster D)” valid bit |
| 1 | “FU <<3>> (cluster D)” valid bit |
| 0 | “FU <<4>> (cluster D)” valid bit |

Each valid bit in the bit mask determines whether that particular functional unit of a “slave” cluster is to replicate an instruction for a corresponding functional unit in a “master” cluster “A”. The machine language instructions refer to the functional units of the master cluster. The assembly language instructions may refer to any of the master cluster and the slave clusters, which are additional clusters in the processor. Through the use of the instruction replication control word, machine language instructions that refer to functional units of the master cluster are replicated in the processor so that they are executed also by functional units of one or more of the slave clusters, in order to accurately implement the assembly language instructions. The 12-bit mask includes one bit per functional unit for each of the three “slave” clusters. It is obvious to a person of ordinary skill in the art how to modify the instruction replication control word for a different number of clusters and/or a different number of functional units per cluster. Moreover, the bits of the bit mask need not be consecutive within the instruction replication control word, and the bits of the bit mask may be in any predefined order.

For example, the assembly language program may include the following instructions to be executed in parallel:
add a0, #5, a1||add b0, #5, b1||add c0, #5, c1||add d0, #5, d1
OR
A.add a0, #5, a1||B.add b0, #5, b1||C.add c0, #5, c1||D.add d0, #5, d1

In this example, the software programmer has indicated that in cluster “A”, the immediate operand #5 is to be added to the contents of register a0 and the sum is to be stored in register a1. Similarly, in cluster “B”, the immediate operand #5 is to be added to the contents of register b0 and the sum is to be stored in register b1. Similarly for clusters “C” and “D”. The assembler tool may determine which cluster is to execute which operation by identifying to which cluster the destination register belongs in each of the assembly language instructions. Alternatively, the assembly language instruction may explicitly identify which cluster is to execute which operation.

The assembler tool may identify that these parallel assembly language instructions use the same operation, namely “add”, the same immediate operand, namely #5, and the same indices of the registers. The assembler tool may therefore use the instruction replication feature to generate an instruction packet having a single machine language instruction for “add a0, #5, a1” and an instruction replication control word to indicate that the machine language instruction is to be replicated in clusters “B”, “C” and “D”. The instruction packet may include additional machine language instructions and control words

For example, the machine language instruction for “add a0, #5, a1” may include one or more bits that indicate that the “add” operation is to be executed by the functional unit <<1>> of cluster “A”. The instruction replication control word may include a bit mask to indicate that the corresponding functional units of clusters “B”, “C” and “D” are to execute the replicated instruction. In the example of the instruction replication control word given hereinabove, the 12-bit mask is 100010001000.

In another example, the assembly language program may include the following assembly language instructions to be executed in parallel:
add a0, a1, a2||sub a7, a8, a9||add b0, b1, b2||sub b7, b8, b9

In this example, the software programmer has indicated that in cluster “A”, the contents of registers a0 and a1 are to be added and the sum is to be stored in register a2, and the contents of register a7 are to be subtracted from the contents of register a8 and the difference is to be stored in register a9. Similarly, in cluster “B”, the contents of registers b0 and b1 are to be added and the sum is to be stored in register b2, and the contents of register b7 are to be subtracted from the contents of register b8 and the difference is to be stored in register b9.

The assembler tool may identify that there are two parallel assembly language instructions that use the same operation, namely “add” and the same indices of the operands, and two parallel assembly language instructions that use the same operation, namely “sub” and the same indices of the operands. The assembler tool may therefore use the instruction replication feature to generate an instruction packet having one single machine language instruction for “add a0, a1, a2”, another single machine language instruction for “sub a7, a8, a9” and a control word to indicate that these machine language instructions are to be replicated in cluster “B”. The instruction packet may include additional machine language instructions and control words.

For example, the machine language instruction for “add a0, a1, a2” may include one or more bits that indicate that the “add” operation is to be executed by the functional unit <<1>> of cluster “A”, and the machine language instruction for “sub a7, a8, a9” may include one or more bits that indicate that the “sub” operation is to be executed by the functional unit <<3>> of cluster “A”. The instruction replication control word may include a bit mask to indicate that the corresponding functional units of cluster “B” are to execute the replicated instructions. In the example of instruction replication control word given hereinabove, the 12-bit mask is 101000000000. Dispatcher 140 will interpret this bit mask as meaning that the machine language instruction in the instruction packet for the functional unit <<1>> of cluster “A” is to be replicated in the functional unit <<1>> of cluster “B”, and the machine language instruction in the instruction packet for functional unit <<3>> of cluster “A” is to be replicated in the functional unit <<3>> of cluster “B”.

The machine language instruction format may include one or more bits to indicate that an instruction is to be executed in cluster “A” or cluster “B”. In such a case, the assembler tool could have converted the assembly language instructions
add a0, a1, a2||sub a7, a8, a9||add b0, b1, b2||sub b7, b8, b9
into four separate machine language instructions. However, assuming that machine language instructions are larger than or the same size as control words, using four separate machine language instructions requires more bits than using the instruction replication feature. With the instruction replication feature, the assembler tool may generate an instruction packet having two machine language instructions and one control word.

In yet another example, the assembly language program may include the following assembly language instructions to be executed in parallel:

add a0, a1, a2 ∥ sub a7, a5, a12 ∥ xor a14, a15, a9 ∥ shift a8, a13 ∥
add b0, b1, b2 ∥ sub c7, c5, a12 ∥ xor d14, d15, d9 ∥
add c0, c1, c2 ∥ sub d7, d5, d12 ∥
add d0, d1, d2

In this example, the software programmer has indicated that in cluster “A”, the contents of registers a0 and a1 are to be added and the sum is to be stored in register a2, the contents of register a7 are to be subtracted from the contents of register a5 and the difference is to be stored in register a12, the contents of register a14 are to be XORed with the contents of register a15 and the result is to be stored in register a9, and register a13 is to be shifted according to the value of the contents of register a8. In cluster “B”, the contents of registers b0 and b1 are to be added and the sum is to be stored in register b2. In cluster “C”, the contents of registers c0 and c1 are to be added and the sum is to be stored in register c2, and the contents of register c7 are to be subtracted from the contents of register c5 and the difference is to be stored in register c12. In cluster “D”, the contents of registers d0 and d1 are to be added and the sum is to be stored in register d2, the contents of register d7 are to be subtracted from the contents of register d5 and the difference is to be stored in register d12, and the contents of register d14 are to be XORed with the contents of register d15 and the result is to be stored in register d9.

The assembler tool may identify the parallel assembly language instructions that use the same operation and the same indices of the operands. The assembler tool may therefore use the instruction replication feature to generate an instruction packet having one single machine language instruction for “add a0, a1, a2”, another single machine language instruction for “sub a7, a5, a12”, another single machine language instruction for “xor a14, a15, a9”, a control word to indicate that these machine language instructions are to be replicated selectively in clusters “B”, “C” and “D”, and another machine language instruction for “shift a8, a13”. The instruction packet may include additional machine language instructions and control words.

For example, the machine language instruction for “add a0, a1, a2” may include one or more bits that indicate that the “add” operation is to be executed by the functional unit <<1>> of cluster “A”, the machine language instruction for “sub a7, a5, a12” may include one or more bits that indicate that the “sub” operation is to be executed by the functional unit <<2>> of cluster “A”, the machine language instruction for “xor a14, a15, a9” may include one or more bits that indicate that the “xor” operation is to be executed by the functional unit <<3>> of cluster “A”, and the machine language instruction for “shift a8, a13” may include one or more bits that indicate that the “shift” operation is to be executed by the functional unit <<4>>. The instruction replication control word may include a bit mask to indicate that the corresponding functional units of clusters “B”, “C” and “D” are to execute the replicated instructions. In the example of instruction replication control word given hereinabove, the 12-bit mask is 100011001110. Dispatcher 140 will interpret this bit mask as meaning that the machine language instruction in the instruction packet for the functional unit <<1>> of cluster “A” is to be replicated in the functional unit <<1>> of clusters “B”, “C” and “D”, that the machine language instruction in the instruction packet for functional unit <<2>> of cluster “A” is to be replicated in the functional unit <<2>> of clusters “C” and “D”, and that the machine language instruction in the instruction packet for functional unit <<3>> of cluster “A” is to be replicated in the functional unit <<3>> of cluster “D”. The machine language instruction in the instruction packet for functional unit <<4>> of cluster “A” is not to be replicated. The instruction replication feature therefore enables selected machine language instructions to be replicated. The instruction replication feature may also be applied selectively to the different clusters.

The examples given hereinabove illustrate the use of machine language instructions for a “master” cluster, namely cluster “A”, while an instruction replication control word is used to selectively replicate selected ones of those instructions in selected ones of “slave” clusters “B”, “C” and “D”. If the machine language instruction format includes one or more bits to indicate that an instruction is to be executed in cluster “A” or cluster “B”, and the processor has four computational clusters, then another option is to use machine language instructions for two “master” clusters, namely clusters “A” and “B”, while an instruction replication control word is used to selectively replicate instructions for cluster “A” to cluster “C”, and to selectively replicate instructions for cluster “B” to cluster “D”. This latter option may be useful, for example, where each computational cluster includes only one functional unit able to execute a particular type of operation, say shift operations, and a software programmer wants to have two different operations of that particular type in parallel and to replicate each of the different operations of that particular type. It should be noted that if the instructions are to be executed only in the “master” cluster or clusters, then the inclusion of an instruction replication control word in the instruction packet is not needed.

It should be noted that in a processor having only two computational clusters, a short instruction replication control word with enough content bits to include a bit mask of one bit per functional unit in one computational cluster is sufficient to provide full support of the instruction replication feature. In a processor having four computational clusters, a long instruction replication control word with enough content bits to include a bit mask of one bit per functional unit for each of three computational clusters is sufficient to provide full support of the instruction replication feature. In such a processor, a short instruction replication control word as described hereinabove may be used with a control bit to provide one option in which instructions for cluster “A” are replicated to cluster “B” and another option in which instructions for cluster “A” are replicated to all of clusters “B”, “C” and “D”. The short instruction replication control word therefore provides partial support of the instruction replication feature, in that the selectivity of clusters to which a machine language instruction is replicated is limited. In this example, the short instruction replication control word does not have enough content bits to provide support for replication to cluster “C” and/or “D”.

The instruction replication control words described herein may therefore be considered to be scalable with respect to the number of computational clusters and with respect to the number of functional units within each cluster.

Instruction Relocation

Before using the instruction replication feature for SIMD, one or more distinct initialization instructions may need to be executed in the clusters that are to execute the replicated instruction. For example, an initial value may be loaded to an internal register of the functional unit. To enable processor 110 to execute an instruction in a “slave” cluster without executing the instruction in a “master” cluster, an instruction relocation feature may be implemented.

In some embodiments of the invention, the instruction replication control words described hereinabove may be used to support the instruction relocation feature by allocating one or more content bits of the control word to distinguish between replication and relocation control words, and, if appropriate, to identify the replication mode. Similarly, a single mechanism in dispatcher 140 may be used to support both the instruction relocation feature and the instruction replication feature.

The software programmer may write an assembly language program having assembly language instructions that refer to “slave” clusters. The assembler tool will automatically identify the relocated instructions and will generate an instruction packet having the appropriate machine language instructions and an instruction relocation control word. Upon receipt of such an instruction packet, dispatcher 140 will issue the operation of the relocated instruction only to the “slave” cluster.

The machine language instructions refer to the functional units of the master cluster. The assembly language instructions may refer to any of the master cluster and the slave clusters, which are additional clusters in the processor. Through the use of the instruction relocation control word, a machine language instruction that refers to a functional unit of the master cluster are relocated in the processor so that they are executed instead by a corresponding functional unit of one of the slave clusters, in order to accurately implement the assembly language instructions.

For example, the assembly language program may include the following assembly language instruction:
add c0, c1, c2
OR
C.add c0, c1, c2

In this example, the software programmer has indicated that in cluster “C”, the contents of register c0 are to be added to the contents of register c1 and the sum is to be stored in register c2. The assembler tool may determine that cluster “C” is to execute the operation “add” by identifying to which cluster the destination register c2 belongs. Alternatively, the assembly language instruction may explicitly identify that the operation is to be executed by cluster “C”. The assembler tool may therefore use the instruction relocation feature to generate an instruction packet having a single machine language instruction for “add a0, a1, a2” and an instruction relocation control word to indicate that the machine language instruction is to be relocated to cluster “C”. The instruction packet may include additional machine language instructions and control words.

For example, the machine language instruction for “add a0, a1, a2” may include one or more bits that indicate that the “add” operation is to be executed by the functional unit <<1>> of cluster “A”. The instruction relocation control word may include a bit mask to indicate that the corresponding functional unit of cluster “C” is to execute the relocated instruction instead of cluster “A”. If the bit mask of the instruction relocation control word is as given hereinabove in the example of the instruction replication control word, the 12-bit mask is 000010000000. Dispatcher 140 will interpret this bit mask as meaning that the machine language instruction in the instruction packet for the functional unit <<1>> of cluster “A” is to be relocated to the functional unit <<1>> of cluster “C”.

In another example, the assembly language program may include the following assembly language instructions to be executed in parallel:
add a0, a1, a2||not b6, b7||xor c12, c9, c15||sub d0, d6, d4

In this example, the software programmer has indicated that in cluster “A”, the contents of registers a0 and a1 are to be added and the sum is to be stored in register a2. In cluster “B”, the logical NOT of the contents of register b6 is to be stored in register b7. In cluster “C”, the contents of register c12 are to be XORed with the contents of register c9 and the result is to be stored in register c15. In cluster “D”, the contents of register d0 are to be subtracted from the contents of register d6 and the difference is to be stored in register d4.

The assembler tool may identify that there are different assembly language instructions using different indices of the operands in the instruction packet, and that the operands refer to registers of different computational clusters. The assembler tool may therefore use the instruction relocation feature to generate an instruction packet having one single machine language instruction for “add a0, a1, a2”, another single machine language instruction for “not a6, a7”, another single machine language instruction for “xor a12, a9, a15”, another single machine language instruction for “sub a0, a6, a4”, and a control word to indicate that these last three machine language instructions are to be relocated in clusters “B”, “C” and “D”, respectively. The instruction packet may include additional machine language instructions and control words.

For example, the machine language instruction for “add a0, a1, a2” may include one or more bits that indicate that the “add” operation is to be executed by the functional unit <<2>> of cluster “A”, the machine language instruction for “not a6, a7” may include one or more bits that indicate that the “not” operation is to be executed by the functional unit <<3>> of cluster “A”, the machine language instruction for “xor a12, a9, a15” may include one or more bits that indicate that the “xor” operation is to be executed by the functional unit <<4>> of cluster “A”, and the machine language instruction for “sub a0, a6, a4” may include one or more bits that indicate that the “sub” operation is to be executed by the functional unit <<1>> of cluster “A”. The instruction relocation control word may include a bit mask to indicate that the corresponding functional units of clusters “B”, “C” and “D” are to execute the relocated instructions. In the example of instruction relocation control word given hereinabove, the 12-bit mask is 001000011000. Dispatcher 140 will interpret this bit mask as meaning that the machine language instruction in the instruction packet for the functional unit <<3>> of cluster “A” is to be relocated to the functional unit <<3>> of cluster “B”, and the machine language instruction in the instruction packet for functional unit <<4>> of cluster “A” is to be relocated to the functional unit <<4>>0 of cluster “C”, and the machine language instruction in the instruction packet for functional unit <<1>> of cluster “A” is to be relocated to the functional unit <<1>> of cluster “D”.

It should be noted that in a processor having only two computational clusters, a short instruction relocation control word with enough content bits to include a bit mask of one bit per functional unit in a computational cluster is sufficient to provide full support of the instruction relocation feature. In a processor having four computational clusters, a long instruction replication control word with enough content bits to include a bit mask of one bit per functional unit for each of three computational clusters is sufficient to provide full support of the instruction relocation feature. In such a processor, a short instruction relocation control word as described hereinabove may be used to relocate instructions from cluster “A” to cluster “B”. The short instruction relocation control word therefore provides partial support of the instruction relocation feature, in that the selectivity of clusters to which a machine language instruction is relocated is limited. In this example, the short instruction relocation control word does not have enough content bits to provide support for relocation to cluster “C” or “D”.

The instruction relocation control words described herein may therefore be considered to be scalable with respect to the number of computational clusters and the number of functional units in each cluster.

Cross-Accumulator Feature

In a processor having two or more computational clusters, a functional unit of one cluster may want to read a register (or an accumulator) of a different cluster for use as an operand.

The cross-accumulator feature may be supported using a cross-accumulator control word. As with other control words, a cross-accumulator control word includes identification bits and content bits. If, for example, each computation cluster includes four functional units, denoted <<1>>, <<2>>, <<3>> and <<4>>, then the content bits of the cross-accumulator control word may include a 20-bit mask, as follows:

| BIT | FIELD |
|---|---|
| 19 | whether cluster D is to read from cluster C or B |
| 18 | whether cluster C is to read from cluster D or A |
| 17 | whether cluster B is to read from cluster A or D |
| 16 | whether cluster A is to read from cluster B or C |
| 15 | “FU <<1>> (cluster A) is to use the cross-register as an |
| | operand” valid bit |
| 14 | “FU <<2>> (cluster A) is to use the cross-register as an |
| | operand” valid bit |
| 13 | “FU <<3>> (cluster A) is to use the cross-register as an |
| | operand” valid bit |
| 12 | “FU <<4>> (cluster A) is to use the cross-register as an |
| | operand” valid bit |
| 11 | “FU <<1>> (cluster B) is to use the cross-register as an |
| | operand” valid bit |
| 10 | “FU <<2>> (cluster B) is to use the cross-register as an |
| | operand” valid bit |
| 9 | “FU <<3>> (cluster B) is to use the cross-register as an |
| | operand” valid bit |
| 8 | “FU <<4>> (cluster B) is to use the cross-register as an |
| | operand” valid bit |
| 7 | “FU <<1>> (cluster C) is to use the cross-register as an |
| | operand” valid bit |
| 6 | “FU <<2>> (cluster C) is to use the cross-register as an |
| | operand” valid bit |
| 5 | “FU <<3>> (cluster C) is to use the cross-register as an |
| | operand” valid bit |
| 4 | “FU <<4>> (cluster C) is to use the cross-register as an |
| | operand” valid bit |
| 3 | “FU <<1>> (cluster D) is to use the cross-register as an |
| | operand” valid bit |
| 2 | “FU <<2>> (cluster D) is to use the cross-register as an |
| | operand” valid bit |
| 1 | “FU <<3>> (cluster D) is to use the cross-register as an |
| | operand” valid bit |
| 0 | “FU <<4>> (cluster D) is to use the cross-register as an |
| | operand” valid bit |

This 20-bit mask includes one bit per computational cluster, and one bit per functional unit for each of the computational clusters. It is obvious to a person of ordinary skill in the art how to modify the cross-accumulator control word for a different number of clusters and/or a different number of functional units per cluster. Moreover, the bits of the bit mask need not be consecutive within the cross-accumulator control word, and the bits of the bit mask may be in any predefined order.

For example, the assembly language program may include the following assembly language instruction:
add b0, a1, a2||abs a13, b7||sub a13, c4, c3||xor c5, d6, d2

The assembler tool may identify that the cross-accumulator feature is being used, and may therefore generate an instruction packet having including:
a machine language instruction for “add a0, a1, a2”, including one or more bits that indicate that the “add” operation is to be executed by the functional unit <<1>>;
a machine language instruction for “abs b13, b7”, including one or more bits that indicate that the “abs” operation is to be executed by the functional unit <<2>>;
a machine language instruction for “sub a13, a4, a3”, including one or more bits that indicate that the “sub” operation is to be executed by the functional unit <<3>>;
a machine language instruction for “xor b5, b6, b2”, including one or more bits that indicate that the “xor” operation is to be executed by the functional unit <<4>>;
an instruction relocation control word to indicate that the “sub” instruction is to be relocated to cluster “C” and the “xor” instruction is to be relocated to cluster “D”; and
a cross-accumulator control word to indicate that the “add” instruction in cluster “A” uses a cross-accumulator from cluster “B”, namely b0, that the “abs” instruction in cluster “B” uses a cross-accumulator from cluster “A”, namely a13, that the “sub” instruction in cluster “C” uses a cross-accumulator from cluster “A”, namely a13, and that the “xor” instruction in cluster “D” uses a cross-accumulator from cluster “C”, namely c5.
   The instruction packet may include additional machine language instructions and control words. In the example of the cross-accumulator control word given hereinabove, the 20-bit mask is 01001000010000100001.

For example, a short cross-accumulator control word may have content bits including an 8-bit mask, as follows:

| BIT | FIELD |
|---|---|
| 7 | “func. unit <<1>> of cluster A is to use a register of cluster |
| | B as an operand” valid bit |
| 6 | “func. unit <<2>> of cluster A is to use a register of cluster |
| | B as an operand” valid bit |
| 5 | “func. unit <<3>> of cluster A is to use a register of cluster |
| | B as an operand” valid bit |
| 4 | “func. unit <<4>> of cluster A is to use a register of cluster |
| | B as an operand” valid bit |
| 3 | “func. unit <<1>> of cluster B is to use a register of cluster |
| | A as an operand” valid bit |
| 2 | “func. unit <<2>> of cluster B is to use a register of cluster |
| | A as an operand” valid bit |
| 1 | “func. unit <<3>> of cluster B is to use a register of cluster |
| | A as an operand” valid bit |
| 0 | “func. unit <<4>> of cluster B is to use a register of cluster |
| | A as an operand” valid bit |

The 8-bit mask includes one bit per functional unit for each of two computational clusters. It is obvious to a person of ordinary skill in the art how to modify the short cross-accumulator control word for a different number of computational clusters and/or a different number of functional units per cluster Moreover, the bits of the bit mask need not be consecutive within the short cross-accumulator control word, and the bits of the bit mask may be in any predefined order.

For example, the assembly language program may include the following assembly age instruction:
xor b10, a11, a12||add a11, b7, b2||sub b10, a4, a3||abs a5, a6

The assembler tool may identify that the cross-accumulator feature is being used, and may therefore generate an instruction packet having including:
a machine language instruction for “xor a10, a11, a12”, including one or more bits that indicate that the “xor” operation is to be executed by the functional unit <<1>> of cluster “A”;
a machine language instruction for “add b11, b7, b2”, including one or more bits that indicate that the “add” operation is to be executed by the functional unit <<2>> of cluster “B”;
a machine language instruction for “sub a10, a4, a3”, including one or more bits that indicate that the “sub” operation is to be executed by the functional unit <<3>> of cluster “A”;
a machine language instruction for “abs a5, a6”, including one or more bits that indicate that the “abs” operation is to be executed by the functional unit <<4>> of cluster A; and
a cross-accumulator control word to indicate that the “xor” instruction in cluster “A” uses a cross-accumulator from cluster “B”, namely b10, that the “add” instruction in cluster “B” uses a cross-accumulator from cluster “A”, namely a11, that the “sub” instruction in cluster “A” uses a cross-accumulator from cluster “B”, namely b10, and that the “abs” instruction in cluster “A” does not use a cross-accumulator.
   The instruction packet may include additional machine language instructions and control words. In the example of the cross-accumulator control word given hereinabove, the 8-bit mask is 10100100.

It should be noted that in a processor having only two computational clusters, a short cross-accumulator control word with enough content bits to include a bit mask of one bit per functional unit in two computational clusters is sufficient to provide full support of the cross-accumulator feature, since cluster “A” can read only from its own accumulator register file and from the accumulator register file of cluster “B”, and cluster “B” can read only from its own accumulator register file and from the accumulator register file of cluster “A”. In a processor having four computational clusters, a short cross-accumulator control word as described hereinabove may be used to provide partial support of the cross-accumulator feature, in that cluster “A” is able to read from the accumulator register file of cluster “B”, but not from that of cluster “D”, and cluster “B” is able to read from the accumulator register file of cluster “A”, but not from that of cluster “C”, and clusters “C” and “D” are able to read only from their own accumulator register files. In such a processor, a long cross-accumulator control word with enough content bits to include a bit mask of one bit per computational cluster and one bit per functional unit for each of four computational clusters is sufficient to provide full support of the cross-accumulator feature.

The cross-accumulator control words described herein may therefore be considered to be scalable with respect to the number of computational clusters and with respect to the number of functional units in each cluster.

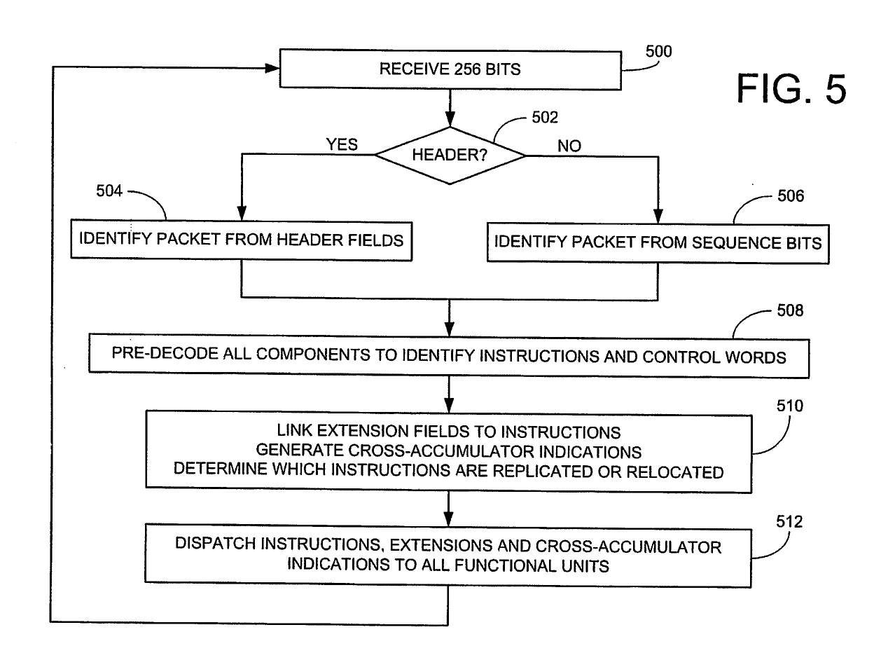

FIG. 5 is a flowchart of a method performed by the dispatcher of the processor of FIG. 1 according to some embodiments of the invention. 256 bits are received at the input of dispatcher 140 (500) and an instruction packet is contained within the 256 bits. Dispatcher 140 checks whether the leftmost 16 bits are a “header” control word (502). If so, then dispatcher 140 identifies the instruction packet from the fields of the header control word (504). If not, then dispatcher 140 identifies the instruction packet from the sequence of bits (506). Identifying the instruction packet includes identifying where the instruction packet ends, how many 16-bit entries are in the instruction packet and how many 32-bit entries are in the instruction packet. For example, the most significant bit of an entry may identify it as the start of a 16-bit entry or the start of a 32-bit entry.

Dispatcher 140 then pre-decodes all the entries to identify the instructions and control words, if any (508). Dispatcher 140 then links the extension fields of the control words to the instructions according to the linkage framework, generates cross-accumulator indications, if any, and determines which instructions are replicated or relocated, if any (510). Dispatcher 140 then dispatches the instructions, extensions and cross-accumulator indications to all functional units (512).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method for translating into machine language assembly language instructions to be performed in parallel, the method comprising:
generating machine language instructions for each of said assembly language instructions;
generating one or more control words for any of said machine language instructions requiring extension fields in order to completely translate the assembly language instructions corresponding thereto, where if a control word format includes sufficient content bits to store particular extension fields for more than one machine language instruction, then said particular extension fields are stored in a single control word that is associated solely with those of said machine language instructions extended by said particular extension fields; and
generating an instruction packet including at least said one or more control words and all of said machine language instructions.

2. The method of claim 1, wherein at least one of said extension fields is additional bits of an immediate operand partially encoded in a machine language instruction.

3. The method of claim 1, wherein at least one of said extension fields is additional bits of an operation partially encoded in a machine language instruction.

4. The method of claim 1, wherein at least one of said extension fields is an optional operand of a machine language instruction.

5. A method comprising:
identifying two machine language instructions and a control word from an instruction packet;
extracting from said control word bits of an immediate operand for an assembly instruction that was translated to one of said machine language instructions; and
extracting from said control word other bits related to another of said machine language instructions.

6. The method of claim 5, further comprising:
dispatching an operation of said one of said machine language instructions to a functional unit together with all bits of said immediate operand; and
dispatching an operation of said other of said machine language instructions to another functional unit together with said other bits.

7. The method of claim 5, further comprising:
identifying a further machine language instruction from said instruction packet; and
extracting from said control word further bits related to said further machine language instruction.

8. A method comprising:
generating an instruction packet including machine language instructions and one or more control words having extension fields for one or more of said machine language instructions,
wherein an association between an extension field and a machine language instruction depends on the relative position of said extension field and said machine language instruction in said instruction packet.

9. The method of claim 8, wherein generating said instruction packet includes:
arranging said one or more control words in a first sequence in said packet;
grouping together in said packet any of said machine language instructions that are not associated with any of said extension fields; and
arranging machine language instructions in a second sequence in said instruction packet so that the position of a particular machine language instruction within said second sequence matches the position of its associated extension field within said first sequence.

10. The method of claim 8, wherein generating said instruction packet includes:
placing a machine language instruction next to a control word having a single extension field for said machine language instruction; and
placing two or more machine language instructions in a group next to a control word having two or more extension fields for said two or more language instructions.

11. A method comprising:
receiving an instruction packet including machine language instructions and one or more control words having extension fields; and
associating each of said extension fields with a corresponding one of said machine language instructions according to the relative position within said instruction packet of said extension fields and said machine language instructions.

12. The method of claim 11, wherein said control words are grouped together in a first sequence in said instruction packet and said machine language instructions are grouped together in a second sequence in said instruction packet, and the position of a particular machine language instruction within said second sequence matches the position of its associated extension field within said first sequence.

13. The method of claim 11, wherein a control word having one or more extension fields is adjacent to the one or more machine language instructions that are extended by said one or more extension fields.

14. A method comprising:
generating an instruction packet having an extended machine language instruction, said instruction packet including at least:
a machine language instruction having encoded bits of an operation; and
a control word including bits of one or more extension fields, wherein the structure and meaning of said extension fields depends upon said extended machine language instruction.

15. The method of claim 14, wherein the size of said control word is the size of said machine language instruction.

16. The method of claim 14, wherein the size of said control word differs from the size of said machine language instruction.

17. The method of claim 14, wherein said one or more extension fields includes an optional operand for said operation.

18. The method of claim 14, wherein said machine language instruction includes least significant bits of an immediate operand of said operation, and said one or more extension fields includes higher-order bits of said immediate operand.

19. The method of claim 14, wherein said instruction packet includes another machine language instruction having encoded bits of another operation, and one of said extension fields is for the first operation and another of the extension fields is for said other operation.

20. A method comprising:
generating an instruction packet having an extended machine language instruction, said instruction packet including at least:
a machine language instruction having encoded bits of an operation; and
a control word including bits of one or more extension fields that influence how the machine language instruction is to be executed,
wherein said encoded bits of said operation encode a valid operation also when not extended by said extension fields.
